(19) United States
(12) Patent Application Publication
(10) Pub. No.: US 2014/0260131 A1
(43) Pub. Date: Sep. 18, 2014

(54) GROW LIGHT COOLING AND GROW ROOM ODOR POLLUTION CONTROL SYSTEM

(71) Applicant: Peter J. Burkhauser, Middleton, CA (US)

(72) Inventor: Peter J. Burkhauser, Middleton, CA (US)

(21) Appl. No.: 13/841,788

(22) Filed: Mar. 15, 2013

(51) Int. Cl. A01G 9/24

(52) U.S. Cl. CPC A01G 9/246
USPC 55/385.2

(57) ABSTRACT

A grow light cooling and grow room odor pollution control system that includes an air plenum with a plurality of air inlets; a plurality of air ducts connecting each air inlet to at least one grow light housing, at least one air outlet; an air pump mounted in the air plenum, and at least one filter operatively coupled to the air pump and disposed between all of the air inlets and the air outlet, such that the air pump pulls hot and odorous air from nearby grow light housings into the air plenum through the air inlets, through the air filter, and then out from the plenum for dissipation in the outside atmosphere or for use in heating a structure.

### CROSS REFERENCES TO RELATED APPLICATIONS

The present application is a continuation-in-part of U.S. patent application Ser. No. 13/516,690, which is a Section 371 application filed Jun. 15, 2012 (Jun. 15, 2012), based on International Patent Number PCT/US10/60605, filed Dec. 15, 2010 (Dec. 15, 2010), which claims the benefit of the filing date of U.S. Provisional Application No. 61/286,725, filed on Dec. 15, 2009 (Dec. 15, 2009), and U.S. Provisional Application No. 61/322,100, filed on Apr. 8, 2010 (Apr. 8, 2010).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates generally to horticultural and agricultural lighting systems for use in indoor plant growing systems, and more particularly to a grow light system lamp cooling and air cleaning manifold for collecting and centralizing air delivered from grow lamp housings and then venting the heated and cleaned air to the outside atmosphere or using it to heat an occupied space.

2. Background Discussion

Indoor plant growing systems are now an integral part of the horticultural and agricultural industries. Such systems include elaborate plant growing structures (table, containers, and so forth), growing media, water delivery systems, and climate control systems that include air circulation, temperature control, and lighting. Many plants respond favorably to prolonged full spectrum light exposure, and grow light systems can provide such an environment.

However, in providing light at high intensity over long periods of time, growers must use grow lamps that operate at very high temperatures, and the heat generated from such lamps must be removed from the growing environment and either vented or passed to the outside for dissipation in the open space or used productively for heating a closed and occupied indoor space. In large indoor growing systems there are multiple hooded lamps employed, and it is impracticable and inefficient to vent each lamp and lamp housing independently. Furthermore, the cumulative odor produced by some plants can be quite unpleasant and can, in fact, be a source of a kind of air pollution, namely air odor pollution.

Accordingly, there is a need for apparatus to collect, process, and redirect heated and odorous air circulating in grow houses and through grow lamps.

### BRIEF SUMMARY OF THE INVENTION

The present invention is a grow light cooling and grow room odor pollution control system. In its most essential aspect, the system comprises an air plenum or manifold of any of a number of shapes, the plenum having a plurality of selectively openable and blockable manifold air inlets. Each manifold air inlet is either blocked or in fluid communication through air ducts with one or more grow light housings or with the upper portions of the air space within a housing dedicated to environmental controlled agriculture. If multiple grow light housings are cooled, the housings may be ganged and joined in fluid communication with one another so as to economize on duct used and to ensure an adequate number of manifold air inlets are available on the air plenum. The plenum also includes at least one air outlet, vented either to another interior structure or to the outside atmosphere. An air pump is mounted within the air plenum and a filter is operatively coupled to the pump. The pump and filter are disposed between all of the air inlets and the air outlet, such that when operating, the air pump pulls air into the plenum through the inlets and the air filter and then out the air outlet.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is an upper front left perspective schematic view showing the inventive manifold that provides a space and medium through which to effect air cooling and odor control using the inventive apparatus;

FIG. 2 a cross-sectional top plan view thereof;

FIG. 3 is a front perspective view showing the inventive apparatus with its end cover removed and the filter revealed;

FIG. 4 is a front left perspective view thereof showing the pump employed for drawing air through the plenum;

FIG. 5 is an upper front perspective view showing a second preferred embodiment of the inventive filter manifold;

FIG. 6 is an exploded view thereof;

FIG. 7 is an upper front left perspective schematic view showing a third preferred embodiment of the inventive air cooling and filtering system of the present invention, showing the system employed not only for cooling lights, but also upper regions in an environmental controlled agriculture housing;

FIG. 8 is an exploded view thereof; and

FIG. 9 is a highly schematic top plan view showing how the inventive system can include ganged air inlets and light housing air feeds.

### DETAILED DESCRIPTION OF THE INVENTION

Referring first to FIGS. 1-4, wherein like reference numerals refer to like components in the various views, there is illustrated therein a new and improved grow light cooling and grow room odor pollution control system of the present invention, generally denominated 10 herein. These views show that the inventive system includes an air plenum 12, preferably a simple cylindrical drum, into which a plurality of proximal air ducts 14 are fed through air inlets 16. In the illustrative views, the system is shown in a simple 4-inlet configuration. However, the system may be adapted for a gang configuration or simply increased in size for incorporation into large grow rooms. The drum includes a closed end 18 and an outlet end 20 through which an air outlet 22 is disposed. The air outlet includes a duct 24 that may be vented to the outside (outdoor) atmosphere or directed to an indoor space for the purpose of heating that space. The air outlet is fed through a resilient or rubberized hole 26 that will expand to accommodate large diameter ducts (e.g., 8 inch diameter) or contract to engage and close around smaller diameter ducts (e.g., 4 inch diameter).

The air inlet and air ducts place the plenum in fluid communication with grow light housings that include air cooling systems served by air outlet vents of the kind shown in U.S. Pat. No. 6,595,662 to Wardenburg and U.S. Pat. No. 6,247,830 to Winnett et al.

The system further includes suspension means to hang the drum from a ceiling or other overhead structure. These means may comprise nothing more than the most elemental and well known apparatus—hooks 28 and chains 30.

Disposed in the drum interior 32 is a filter and pump support 34 comprising platform elements in any of a number of suitable configurations. Because the manifold in the illustrations is cylindrical, at least one activated charcoal filter 36 having a complementary shape may be provided, in this instance a single cylindrical filter. The filter is placed on the filter support portion of the platform and includes couplers 38 on its front end 40 for attaching the filter to a pump 42, the latter which is disposed on the pump portion of the platform and coupled to the activated charcoal filter in such a way that when operating, air drawn into the drum through the air ducts and air inlets must pass through the filter and pump before passing out of the drum to and through the air outlet 22 and outlet air duct 24 and eventually to the outside atmosphere. By the time it reaches outside air, it has been scrubbed of unpleasant odors, many particulates, and other contaminants, and hot air is effectively vented away from the grow house and grow light housings.

Referring next to FIGS. 5-6, wherein like reference numerals refer to like components in these two views, there is illustrated therein a second preferred embodiment of the new and improved grow light cooling and odor pollution control system of the present invention, this second embodiment being generally denominated 50 herein.

In the second preferred embodiment, the inventive system comprises a housing frame 52 that includes a pair of motor mount brackets 53 disposed on the upper surface of a motor platform or base 54. The base includes a plurality of upright supports 56 that may be shaped and fashioned in any of a number of ways to define and configure the interior volume of the housing. In a preferred embodiment, the upright supports are either uniformly bent arches or a combination of geometric elements that form arches and that include at least vertical supports 58, angled portions 60, a horizontal support 62, all tied in fixed spaced apart relationships by one or more purlins 64. The arches are fixed at their lower ends in the frame base 54. Chain or cable hangers 66 extend upwardly from two or more of the horizontal supports.

A motorized pump 68 of the kind discussed in connection with the first preferred embodiment is installed on the base. A fabric housing cover 70 is then fitted around the base. The fabric is preferably a heat tolerant material with a silver reflective exterior layer that reflects light and resists heat transfer in both directions. The material includes a closure 72 at the top, either in the form of a zipper, hook and loop fastener materials, snaps, or other closure methods well known in the art.

Air duct ports 74 are disposed along each side of the fabric housing. Each port is preferably a circular opening circumscribed by elastic material that enables the opening to fit tightly around ducts of various sizes (generally from about 4 to 8 inches in diameter). If less than all of the ducts are to be employed, plugs 76 can be installed in the unused port. These plugs can be retained either by the elastic material itself (which can be fitted snugly enough to resist movement of the plugs during pump operation) or by other fastening means such as hook and loop material, snaps, and the like.

Referring next to FIGS. 7-9, there is shown a third preferred embodiment 90 of the inventive grow light cooling and grow room odor pollution control system, in this instance employed to cool not only lights, but also to draw air from the upper regions in an environmentally controlled agriculture structure. Structurally, the third preferred embodiment is identical in most respects to the second preferred embodiment described above. However, fabric cover 92 is modified to include sleeves 94 with drawstrings 96 at their distal ends. To further enhance the coupling of the proximal air ducts 82 from the grow lights 80, foam collars 98 can be disposed around the proximal end of the ducts so as to be engaged by the drawstring 96 portion of the sleeves 94. Additional air filter ducts 100 can be provided and connected to one or more of the manifold air inlet sleeves to pull hot air away from the upper regions of the interior grow room structure. The air filter ducts dedicated to this purpose couple to the drawstring sleeves precisely as do the proximal air inlet ducts from the grow lights, but rather than coupling to a light housing, the distal ends of the ducts are simply suspended in open space near the ceiling of the structure. Accordingly, the open end of the air filter duct is available to draw in the ambient air. Because such air may include considerable particular material and insects, the distal ends preferably include a foam and filter sock 102 covering the opening at the end so as to prevent dust and insects from getting pulled into the filtering system. This will reduce the need to replace the filter cartridges, which are both more expensive and more difficult to access.

FIG. 9 schematically shows how the third embodiment can be incorporated into a highly complex, ganged system 110 which directly addresses both light housing heat and room heat, and even contributes to the removal of dust, insects, and other particulate matter. Components include those already discussed in detail, but further include a drawstring sleeve 112 in manifold cover 92 for pump power cord 114. Next the air supply to the light housings 80 is ganged through air inlet gang boxes 116, 118 fed by primary air inlet ducts 120, 122, and having filter material 124, 126 disposed interiorly so as to provide a course filtering of ambient air drawn through the light housings. This is a course filter that selects for particles exceeding a predetermined size, but does not seek to capture entrained particles of any particular molecular composition. In this manner, air drawn from outside the grow room can be freed from particulates and insects that would otherwise coat the light bulb and light lens and reduce light insolation.

Once air has been drawn through the air inlet gang boxes 116, 118, it is pulled through a plurality of primary air ducts 128, through the light housings 80, through the proximal air ducts 82, and then into the manifold 90 where the hot but coarsely filtered air is again filtered by an activated charcoal (or otherwise treated filter) before being forced through outlet duct 24 by pump 42. Odors and other potentially polluting particles are selectively captured and eliminated from the discharged air. If desired as a component in the overall system, an air conditioning unit 130 for providing cool air 132 into the grow room may have its heated air conveyed through duct 134 and joined with air from the manifold 90. Again, this confluence of air flows may be discharged directed to outside air, or, alternatively, it may be joined in a junction box 136, where it can be selectively directed to outside air through duct 138 or to an interior structure through duct 140, or it can be divided in even or dissimilar portions by adjusting apertures in the openings to the ducts, in a manner not discussed herein but well known.

According to each of the above-described embodiments of the present invention, hot and odorous air 78 pulled from the grow room, directly from the grow a light housings 80, and from the hotter upper regions of a grow room, and thereafter conveyed through ducts 14, 82 to an air cleaning manifold 10, 50, 90, can be passed through one or more activated charcoal (or other selective) filters 36, 68, deodorized, and then redirected either to an indoor space for heating, thereby effecting considerable cost savings during cold weather, or vented to the outside atmosphere for dissipation.

The foregoing disclosure also provides the essential elements to practice a novel method of cooling grow lights and deodorizing grow rooms by combining a system for light housing cooling and a system for air filtration system in an overhead air intake manifold/air plenum which houses both the filter and the pump. Consolidating functions economizes on energy and at least potentially provides means for capturing waste heat generated by grow lights in the form of heated air, scrubbing the air of unpleasant odors, and then re-using the air by ducting it back into a structure in need of heat.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A grow light cooling and grow room odor pollution control system, comprising:
an air plenum having a plurality of air inlets;
a plurality of proximal air ducts, at least one each connected to one of said air inlets at one end and to a grow light housing at another end;
at least one air filtering duct having a free end suspended and unconnected to any apparatus and covered by filter material;
at least one air outlet;
an air pump mounted within said air plenum; and
at least one filter operatively coupled to said air pump and disposed between all of said air inlets and said at least one air outlet;
wherein said air pump pulls air into said air plenum through said air inlets, through said air filter, and then discharges air out said air outlet.

2. The grow light cooling and grow room odor pollution control system of claim 1, where said air plenum comprises a metal frame covered by a fabric housing cover.

3. The grow light cooling and grow room odor pollution control system of claim 2, wherein said housing frame includes a metal platform base and said air pump and filter are mounted on a pair of motor mount brackets disposed on said base.

4. The grow light cooling and grow room odor pollution control system of claim 3, wherein said housing frame further includes a plurality of upright supports with arched upper portions and having lower ends affixed to said platform base.

5. The grow light cooling and grow room odor pollution control system of claim 4, wherein said fabric housing includes a plurality of air inlets disposed in at least one side.

6. The grow light cooling and grow room odor pollution control system of claim 5, wherein said fabric housing cover is made from a heat tolerant material with a silver reflective exterior layer that reflects light and resists heat transfer in both directions.

7. The grow light cooling and grow room odor pollution control system of claim 6, wherein said air inlets in said fabric housing cover extend outwardly to a fabric sleeve terminated at a distal end with a drawstring that enables said fabric sleeve to fit tightly around ducts of various sizes.

8. The grow light cooling and grow room odor pollution control system of claim 1, further including suspension means to hang said air plenum from an overhead structure.

9. The grow light cooling and grow room odor pollution control system of claim 1, further including an air duct having an outlet that provides heated filtered air to a structure in need of heating.

10. The grow light cooling and grow room odor pollution control system of claim 1, further including at least one air inlet gang box from which a plurality of primary air inlet ducts extend to one or more of said grow light housings, each of said grow light housings connected to said air plenum through one of said proximal air ducts.

11. The grow light cooling and grow room odor pollution control system of claim 10, wherein said gang box includes a particle filter so as to filter particles from feed air before discharge to said grow lights.

12. The grow light cooling and grow room odor pollution control system of claim 1, further including an outlet junction box for dividing the outlet air path between a path directed to outside atmosphere and a patch to a structure interior.
